(19) United States
(12) Patent Application Publication
(10) Pub. No.: US 2022/0188718 A1
(43) Pub. Date: Jun. 16, 2022

(54) ADVANCED BEHAVIOR-BASED SAFETY NOTIFICATION SYSTEMS AND METHODS

(71) Applicant: Caterpillar Inc., Peoria, IL (US)

(72) Inventors: Shane M. Snyder, Peoria, IL (US); Mandy K. Chadwick, Peoria, IL (US); Brent R. Ruth, Edwards, IL (US); William J. Fisher, Peoria, IL (US); Rita Osborne, Washington, IL (US)

(21) Appl. No.: 17/122,994

(22) Filed: Dec. 15, 2020

(51) Int. Cl. G06Q 10/06; G08B 21/02; G06Q 10/10

(52) U.S. Cl. CPC G06Q 10/0635; G06Q 10/06311; G06Q 10/10; G08B 21/02

(57) ABSTRACT

The present disclosure is directed to systems and methods for an advanced behavior-based safety system. In some embodiments, the advanced behavior-based safety system receives data associated with one or more observed safety violations, each with a set of assessment parameters, at a location. Based upon the assessment parameters, an observed safety violation can be evaluated as to whether it exceeds a notification threshold according to a risk assessment protocol. Depending on whether the notification threshold is exceeded, a notice of the observed safety violation may be transmitted or scheduled for transmission to a management entity having a unique notification address. In some embodiments, an aggregation of the assessment parameters of all observed safety violations can also be determined, and the aggregation further evaluated to determine whether a notice of the observed safety violations should be transmitted to a management entity.

### TECHNICAL FIELD

The present disclosure relates to a system and method for allowing user entities to create safety observations and notify other entities of real-time observed safety violations typical within an industrial setting.

### BACKGROUND

Work environments can pose a number of safety concerns or hazards for workers. The equipment at a facility may be malfunctioning, an oil spill at a geographic location may have occurred, tools may be unavailable, or undesirable conditions may be detected by sensors in a building. Workers themselves, too, may perform actions at a location that warrant concern or present safety hazards that should be reported to managers or leaders. Tools or processes to communicate such safety concerns or hazards to different channels are desirable. Conventional tools or processes to channelize the safety at a location or about a worker typically rely upon database management tools, which often present robustness and reliability issues. There also exist timeouts, crashes, or other connectivity disruptions with the global information system (GIS) employed with current systems and methods, particularly where conventional tools or processes require significant overhead and processing resources.

For example, Chinese Patent Application No. CN111062686A to Du (hereinafter “Du”) describes a mobile intelligent supervision and control method based on a digital model that exemplifies some of the disruptions caused by these systems. In particular, Du discloses the input of project field management data into a 3D digital model. As a result, the ability to send real-time observation notifications to related managers, leaders and/or supervisors, along with consistent reporting of worker's observed behaviors of one another based upon safety violations, is lacking from the high-processing demand systems described by Du.

There is a need for interconnected systems and methods to communicate safety to desired channels in a robust and reliable fashion. Many current systems and methods are obsolete, are expensive to manage, are no longer supported, and lack the ability to integrate multiple aspects of workplace safety communication into one. There is a need for systems and methods to allow workers to be able to keep an eye on their own and their peer's daily safety behavior, enable workers to engage with peers and management regarding safety violations, allow management to monitor the work process safety, and provide users the option to communicate with auditors regarding ways to address unsafe behavior. Furthermore, there is a desire for systems and methods related to collection of sensory data to be integrated into the communication pipeline so that such data can be tapped into and utilized for predictive analytics that prevent safety concerns or hazards from escalating.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 is a system diagram illustrating the communications map the disclosed system operates in some embodiments of the present technology.

FIG. 2 is a flow diagram showing steps typically performed by the advanced behavior-based safety system to notify a management entity of an observed safety violation.

FIG. 3 is a flow diagram showing steps typically performed by the advanced behavior-based safety system to notify a management entity of corrective behaviors to be taken.

FIG. 4 is a flow diagram showing steps typically performed by some embodiments of the advanced behavior-based safety system to receive a mitigation or resolution procedure from an auditor to deal with an observed safety violation.

FIG. 5 is an example of an interface of the advanced behavior-based safety system for receiving a language selection from a user entity.

FIG. 6 is an example of an interface of the advanced behavior-based safety system for receiving a new observation entry from a user entity.

FIG. 7 is an example of an interface of the advanced behavior-based safety system for receiving observation data from a user entity.

FIG. 8 is an example of an interface of the advanced behavior-based safety system for receiving location information from a user entity.

FIG. 9 is an example of an interface of the advanced behavior-based safety system for receiving one or more observed safety violations.

FIG. 10 is an example of an interface of the advanced behavior-based safety system for receiving a severity level associated with an observed safety violation from a user entity.

FIG. 11 is an example of an interface of the advanced behavior-based safety system with default entries for an observed safety violation from a user entity.

FIG. 12 is an example of an interface of the advanced behavior-based safety system for receiving an observed safety violation entry from a user entity.

FIG. 13 is an example of an interface of the advanced behavior-based safety system for receiving a selection from a user entity to transmit an immediate notification of an observed safety violation to a management entity.

FIG. 14 is an example of an interface of the advanced behavior-based safety system for receiving management entity information from a user entity.

FIG. 15 is an example of an interface of the advanced behavior-based safety system for receiving additional observation information from a user entity.

FIG. 16 is an example of an interface of the advanced behavior-based safety system for receiving observation comments and attachments from a user entity.

FIG. 17 is an example of an interface of the advanced behavior-based safety system for displaying confirmation of receipt of an observation entry from a user entity.

FIG. 18 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

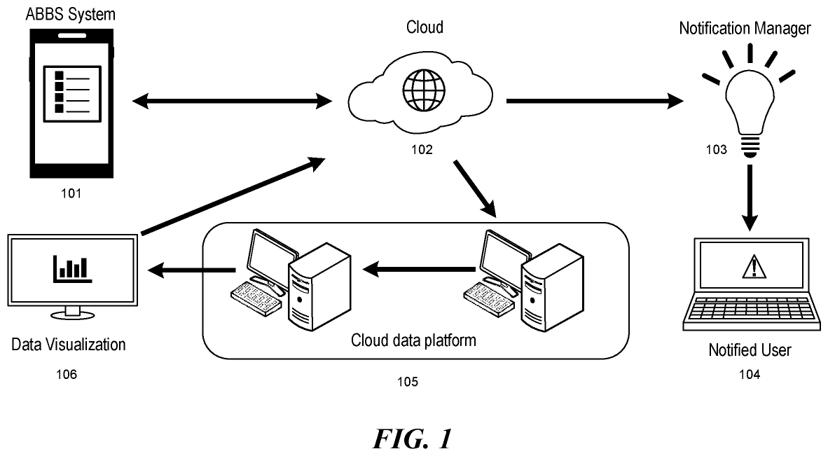

FIG. 1 is a system diagram illustrating the communications map the disclosed system operates in some embodiments of the present technology. System 101 is a mobile device or general computing device running an advanced behavior-based safety system that receives data entries from a user entity through an interface. Data (e.g. observation, location, observed safety violations, sensory) received by the advanced behavior-based safety system can be transmitted over the cloud 102 to devices that access the data. System 103 manages the notifications transmitted over the cloud to make sure they get to the proper devices such as a notified user entity 104. In some embodiments, notified user entity 104 is a management entity that receives notice of an observed safety violation from the system 101. In some embodiments, notified user entity 104 is an auditor that determines a mitigation or resolution procedure for an observed safety violation. In other embodiments, notified user entity 104 is an entity for determining corrective behaviors to take after evaluating sensory, temporal, or geoinformation data in the cloud transmitted from the advanced behavior-based safety system. System 105 is the cloud data platform with one or more computing system that operate and manage the cloud 102. System 106 contains data visualization tools for user entity entities to access data in the cloud including those transmitted from the advanced behavior-based safety system. In some embodiments, an auditor may use the data visualization tools to assist with performing an audit of the observed safety violation and determining a mitigation or resolution procedure.

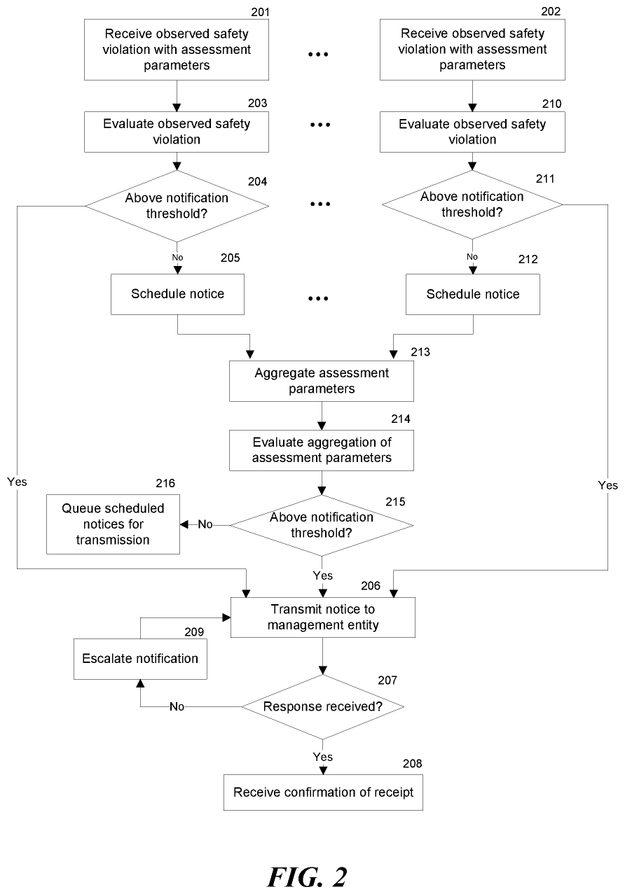

FIG. 2 is a flow diagram showing steps typically performed by the advanced behavior-based safety system to notify a management entity of an observed safety violation, which can also be known as a risk behavior. In step 201, the advanced behavior-based safety system receives data associated with a first observed safety violation (at a location) that includes a set of assessment parameters. In some embodiments, the advanced behavior-based safety system can receive data associated with a second observed safety violation (at a similar or different location from the first) that includes a set of assessment parameters, in step 202. In some embodiments, the first observed safety violation and second observed safety violation are received sequentially and processed sequentially (the first observed safety violation and then second observed safety violation, in that order). In some embodiments, the first observed safety violation and second observed safety violation are received in parallel, and the order they are processed in is in parallel or determined by a scheduler. The first observed safety violation and second observed safety violation are not the only observed safety violations that can be received by the advanced behavior-based safety system, and the ellipses of FIG. 2 indicate that additional observed safety violations beyond the first observed safety violation and second observed safety violation can be received. In some embodiments, the advanced behavior-based safety system only receives the first observed safety violation.

In step 203, based on one of more of the assessment parameters, the first observed safety violation is evaluated as to whether it exceeds a notification threshold according to the risk assessment protocol. The assessment parameters can include, but are not limited to, a date, an observer, an observee, the location, a severity level, and/or one or more entities identified to be associated with the safety violation. The location parameter can include information such as the geographic location, longitude/latitude, facility name, cell number, section number, machine location, equipment location, machine number, equipment number, building area, building number, column number, column letter, office location, and/or outdoor location of the observed safety violation. The location can be identified by an associated risk level. The severity level parameter is associated with a risk value weighted according to a risk assessment protocol. The risk value can be a continuous or discrete numerical weight value. In some embodiments, the risk value can be 4 distinct discrete weights representing different levels of risk including: minor, major, catastrophic, and safe (the default weight). Minor may indicate the observed safety violation is insignificant, major may indicate the observed safety violation is moderate, and catastrophic may indicate the observed safety violation is critical. in some embodiments, the risk value is a default weight value that when evaluated can be above or below the notification threshold. The one or more entities identified parameter can include management entities having unique notification addresses or supervisor reporting chains that are to receive reporting of the observed safety violation. In some embodiments, the first observed safety violation can be evaluated by aggregating all or a subset of weights or values assigned to each of the assessment parameters. In some embodiments, the first observed safety violation can be evaluated by using the assessment parameters as features of a machine learning algorithm to determine whether the observed safety violation exceeds the notification threshold. In other embodiments, the first observed safety violation can be evaluated by an evaluator or alternatively an auditor with administrative privileges that examines the assessment parameters in part or whole to determine whether the observed safety violation exceeds the notification threshold.

In step 204, the evaluated first observed safety violation is determined to be either above or below a notification threshold according to the risk assessment protocol. The notification threshold according to the risk assessment protocol can be adjustable. When the evaluated first observed safety violation is determined to be below the notification threshold, a transmission of a notice of the first observed safety violation to the management entity having a unique notification address is scheduled in step 205. When the evaluated first observed safety violation is determined to be above the notification threshold, a notice is transmitted to a management entity having a unique notification address in step 206. In some embodiments, the notice is sent immediately to the management entity. In some embodiments, the advanced behavior-based safety system can transmit a request for a response that the notice of the first observed safety violation was received to the management entity, in step 207. When a response is received from the management entity, the advanced behavior-based safety system can receive a confirmation of receipt from the management entity. When a response is not received from the management entity, in step 209 the notice of the first observed safety violation can be escalated, and a notice of the first observed safety violation can be transmitted to the management entity so long as a response is not received from the management entity.

In some embodiments, based on one of more of the assessment parameters, the second observed safety violation can be evaluated as to whether it exceeds a notification threshold according to the risk assessment protocol, in step 210. The evaluation can either occur sequentially after or in parallel with the evaluation of the first observed safety violation. In step 211, the evaluated second observed safety violation can be determined to be either above or below the notification threshold according to the risk assessment protocol. When the evaluated second observed safety violation is determined to be below the notification threshold, a transmission of a notice of the second observed safety violation to the management entity having a unique notification address can be scheduled in step 212. When the evaluated second observed safety violation is determined to be above the notification threshold, a notice can be transmitted to a management entity having a unique notification address in step 206. In some embodiments, the notice is transmitted immediately to the management entity and the transmission of observed safety violations that have been scheduled (e.g. a first observed safety violation scheduled for transmission of a notice) are deferred. In step 207, the advanced behavior-based safety system can transmit a request for a response that the notice of the second observed safety violation was received to the management entity. When a response is received from the management entity, the advanced behavior-based safety system can receive a confirmation of receipt from the management entity. When a response is not received from the management entity, in step 209 the notice of the second observed safety violation can be escalated, and a notice of the second observed safety violation can be transmitted to the management entity so long as a response is not received from the management entity.

In some embodiments, the assessment parameters of all or a subset of the observed safety violations with scheduled transmissions of notices can be aggregated, in step 213. In some embodiments, the aggregation can be performed by aggregating the weights or values of all or a subset of the assessment parameters via an aggregation function (e.g. sum of all, sum of the first and second observed safety violations). In step 214, based on one of more of the aggregated assessment parameters, the determined aggregation of the observed safety violations can be evaluated as to whether it exceeds the notification threshold according to the risk assessment protocol. In step 215, the evaluated aggregation of the observed safety violations can be determined to be either above or below the notification threshold according to the risk assessment protocol. When the evaluated aggregation of the observed safety violations is determined to be below the notification threshold, the scheduled notices of the observed safety violations can be queued for transmission in step 216. When the evaluated aggregation of the observed safety violations is determined to be above the notification threshold, notices of all the observed safety violations aggregated can be transmitted to their corresponding management entities with unique notification addresses in step 206. In some embodiments, the notices of all the observed safety violations aggregated can be sent immediately to the management entity. In step 207, the advanced behavior-based safety system can transmit a request for a response that the notice of all the observed safety violations aggregated was received to the management entity. When a response is received from the management entity, the advanced behavior-based safety system can receive a confirmation of receipt from the management entity. When a response is not received from the management entity, in step 209 the notices of all the observed safety violations aggregated can be escalated, and notices of all the observed safety violations aggregated can be transmitted to their corresponding management entities so long as a response is not received from the management entities.

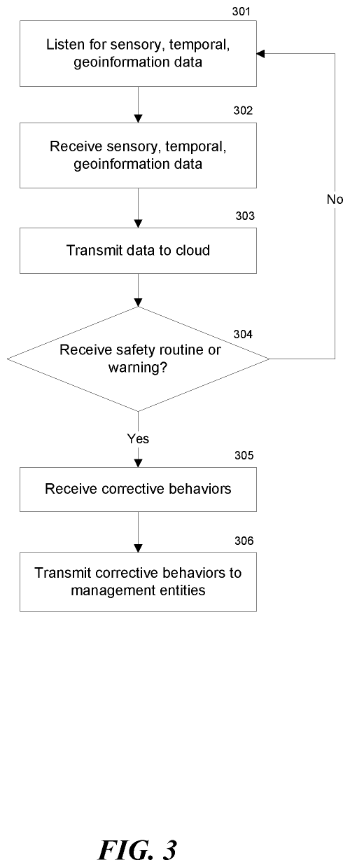

FIG. 3 is a flow diagram showing steps typically performed by the advanced behavior-based safety system to notify a management entity of corrective behaviors to be taken from sensory data. The steps performed can occur in parallel with the notification steps in FIG. 2. In step 301, the advanced behavior-based safety system listens for sensory, temporal, or geoinformation data collected at a location. In some embodiments, the advanced behavior-based safety system queries for sensory, temporal, or geoinformation data. In step 302, the advanced behavior-based safety system can receive sensory, temporal, or geoinformation data when listening for data. The data can come from any sensors that monitor safety activity and violations at a location (e.g. facility, building, equipment) and output data including, but not limited to, temperature, humidity, sound/noise, speed/motion, radiation, imaging, pressure, proximity, leak, gas, force, and/or electrical. In step 303, the collected sensory, temporal, or geoinformation data is transmitted to the cloud, where it may be accessed by other computing systems or entities to evaluate.

After evaluation of the sensory, temporal, or geoinformation data, the advanced behavior-based safety system determines whether a safety routine or warning relevant to the location is received after the data is evaluated. In some embodiments, the safety routine or warning may be an indication that there is a safety violation or equipment malfunction at the location of the sensors. In some embodiments, the safety routine or warning may occur during a time period when the probability of a safety concern is high, such as during periods before holidays when people are rushing to complete their work at the location. When a safety routine or warning is not received, the advanced behavior-based safety system returns to step 301 and continues to listen for data. When a safety routine or warning is received, the advanced behavior-based safety system can receive corrective behaviors associated with the location. Corrective behaviors can be behaviors taken to mitigate or resolve a possible safety violation at the location, such as adjustments to the settings of entities (e.g. equipment, machines, devices, systems) monitored by sensors, methods to reduce hazards at a facility/building, or general procedures or behaviors that individuals at the location should take to prevent escalation of safety concerns or safety violations. In step 306, the corrective behaviors are transmitted to reporting systems where one or more management entities are responsible for managing the location at which the sensory, temporal, or geoinformation data come from can review the information. The management entities can then assign or carry out the necessary corrective behaviors at the location.

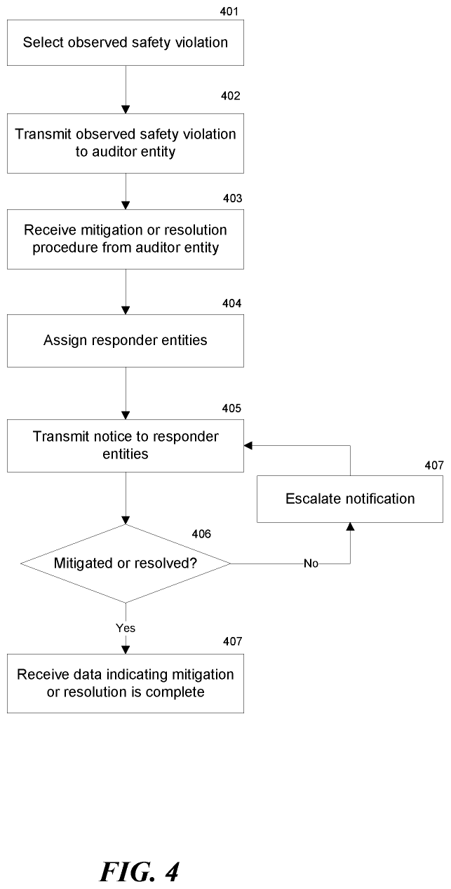

FIG. 4 is a flow diagram showing steps typically performed by some embodiments of the advanced behavior-based safety system to receive a mitigation or resolution procedure from an auditor to deal with an observed safety violation. In step 401, the advanced behavior-based safety system can select an observed safety violation that can be audited. The selected observed safety violation can be one arbitrarily selected or one with a notice transmitted most recently to a management entity. For example, if the second observed safety violation is notified immediately while the first observed safety violation is scheduled a transmission of notice, the second observed safety violation could be selected first. In step 402, data associated with the selected observed safety violation can be transmitted to an auditor entity. The auditor entity can notify an audit committee to perform an audit of the observed safety violation. The auditor may determine mitigation or resolution procedures to mitigate or resolve the observed safety violation at the location. The audit committee may visit the location of the observed safety violation to further determine the context of the violation to be better informed of procedures best to be taken. In some embodiments, the auditor can use sensory, temporal, or geoinformation data transmitted to and stored in the cloud in step 303 of FIG. 3 to assist with determining mitigation or resolution procedures.

In step 403, the advanced behavior-based safety system can receive mitigation or resolution procedures determined by the auditor entity. In step 404, the advanced behavior-based safety system can assign one or more responder entities to carry out the mitigation or resolution procedure in order to respond to the observed safety violation. The assignment of the responder entities can depend on the location the responder entities are responsible for and/or the availability of the responder entities. For example, if location X requires a mitigation or resolution procedure to be carried out, the responder entity responsible for addressing safety violations at location X could be assigned the task of carrying out the mitigation or resolution procedure. The availability of the responder entities can also play a factor in the assignment, since a responder entity that is not available could not be assigned the procedure. In step 405, a notice of the mitigation or resolution procedure to be carried out can be transmitted to the responder entities. In step 406, the advanced behavior-based safety system can determine from an indication whether the responder entities have carried out the mitigation or resolution procedure. The indication can be a notification received from the responder entities of whether the observed safety violation has been mitigated or resolved. When the mitigation or resolution procedure has not been carried out yet, the notification of the procedure can be escalated in step 407 and the responder entities are again notified in step 405. When the mitigation or resolution procedure has been carried out, the advanced behavior-based safety system can receive data from the responder entities indicating the mitigation or resolution is complete in step 407.

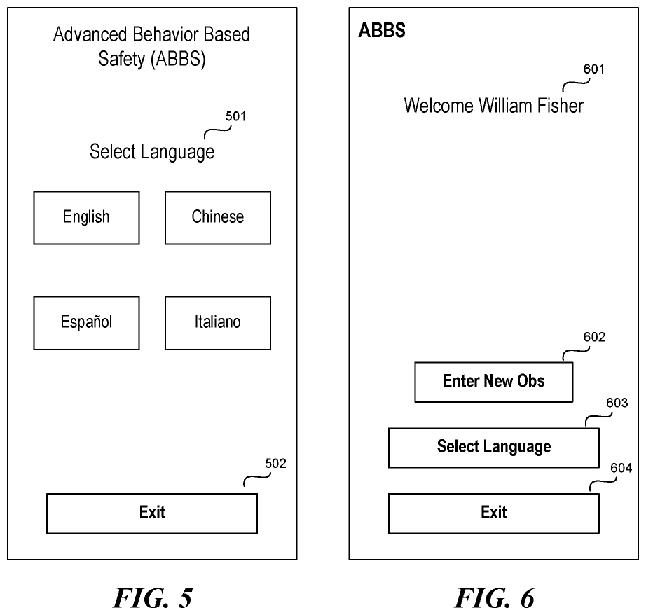

FIG. 5 is an example of an interface of the advanced behavior-based safety system for receiving a language selection from a user entity. The interface can either be that of a mobile device or general computing device. Elements of the interface can be selected via a touch-screen, a mouse, and/or a keyboard. Element 501 allows a user entity to select a language of preference, which can include, but is not limited to, English, Chinese, Espanol, or Italiano. The advanced behavior-based safety system will receive the language preference from the user entity, and further menu elements beyond the selection menu will be displayed in the preferred language. Element 502 allows a user entity to select exiting the interface, and the advanced behavior-based safety system will receive an indication that the user entity does not want to use the advanced behavior-based safety system anymore. The exit option can shut down the advanced behavior-based safety system, put the advanced behavior-based safety system in a sleep mode until the interface is launched again, or keep the advanced behavior-based safety system running in the background.

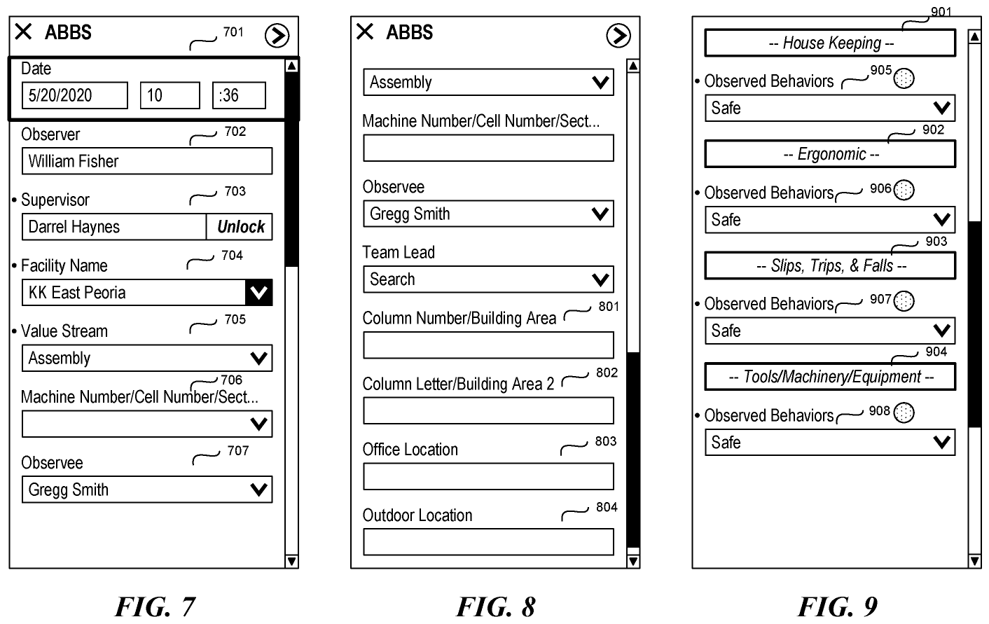

FIG. 6 is an example of an interface of the advanced behavior-based safety system for receiving a new observation entry from a user entity. Element 601 can display the name of the user entity (e.g. William Fisher) of the interface, which can be the name of the observer entering a new observation in element 602. Element 602 allows a user entity to select the option to enter a new observation in the interface. The advanced behavior-based safety system will receive an indication that a user entity could like to enter a new observation. When the indication is received, the advanced behavior-based safety system will return to the system an interface to enter observed safety violations at a location shown in FIG. 7. Element 603 allows a user entity to return to the language selection menu and change the language preference. When selected, the advanced behavior-based safety system will receive an indication of the selection and return the user entity to the language selection menu of FIG. 5. Element 604 allows a user entity to select exiting the interface, and the advanced behavior-based safety system will receive an indication that the user entity does not want to use the advanced behavior-based safety system anymore. The exit option can shut down the advanced behavior-based safety system, put the advanced behavior-based safety system in a sleep mode until the interface is launched again, or keep the advanced behavior-based safety system running in the background.

FIG. 7 is an example of an interface of the advanced behavior-based safety system for receiving observation data from a user entity. The advanced behavior-based safety system receives inputs of data related to the observation, which can be assessment parameters of observed safety violations. In the highlighted entry 701, the advanced behavior-based safety system receives a date. The date can correspond to the time at which the observation was entered to the interface by the user entity or the time at which an observer (which can be the user entity or another party that the user entity is entering the observation for) made the observation. In entry 702, the advanced behavior-based safety system receives information regarding the observer, which is the person who made the observation. The observer can be the user entity himself/herself (e.g. William Fisher) after making an observation. In entry 703, the advanced behavior-based safety system receives information regarding the supervisor (e.g. the name Daniel Haynes) of the observer or user entity. In some embodiments, each observer has a corresponding supervisor assigned or locked to them. In some embodiments, the supervisor can be unassigned or unlocked and changed by the user entity via a manual entry to be parsed by the advanced behavior-based safety system. The observer can also be unassigned or unlocked and changed by the user entity via a manual entry to be parsed by the advanced behavior-based safety system. In entry 704, the advanced behavior-based safety system receives the name of the facility at which the observation occurred. The facility name can be selected by the user entity from a default list of facilities stored in the advanced behavior-based safety system or alternatively can be manually entered by the user entity to be parsed by the advanced behavior-based safety system. In entry 705, the advanced behavior-based safety system receives information regarding the value stream related to the observation. In entry 706, the advanced behavior-based safety system receives the machine number, cell number, or section number associated with the observation. This entry can be selected by the user entity from a default list of machine numbers, cell numbers, or section numbers stored in the advanced behavior-based safety system or manually entered by the user entity to be parsed by the advanced behavior-based safety system. In entry 707, the advanced behavior-based safety system receives information regarding the observee of the observation. The observee information can be the name, position, or profile of the observee.

FIG. 8 is an example of an interface of the advanced behavior-based safety system for receiving location information from a user entity. In entries 801 and/or 802, the user entity can specify the column number and/or the column letter respectively, and the advanced behavior-based safety system receives the column number and/or column letter specified. In some embodiments, the column number and column letters can relate to the building area where the observation is made. The user entity can also further specify the exact office location or outdoor location at which the observation occurs, and that information is received by the advanced behavior-based safety system in entries 803 and 804. The office location or outdoor location can correspond to a specific location in the building area where the observation occurred.

FIG. 9 is an example of an interface of the advanced behavior-based safety system for receiving one or more observed safety violations, which can also be known as risk behaviors, from a user entity. An observation is made up of these observed safety violation entries. An observed safety violation can be composed of a safety violation type 901, 902, 903, and 904, and a corresponding observed behavior entry 905, 906, 907, and 908 associated with the type. The observed safety violations can come from a preexisting list of safety violations stored on the advanced behavior-based safety system or can alternatively be manually entered by a user entity. Example types of safety violations that can occur include, but are not limited to, house-keeping, ergonomics, slips, trips and falls, tools/machinery/equipment, and usage of personal protective equipment. The lack of house-keeping can create hazards at a location resulting in safety violations. Tools, machinery, or equipment could be malfunctioning or damaged, also posing a safety violation. Furthermore, slips, trips and falls could result in serious injuries to observees and are behaviors that benefit from being observed. The default entry for an observed safety violation is “Safe”, which indicates there is not an observed behavior of the corresponding type (e.g. the observed safety violation “House Keeping” has a default entry of “Safe” in entry 901). The observation data and location information from FIG. 7 and FIG. 8 can be used by the advanced behavior-based safety system as assessment parameters for each of the observed safety violations.

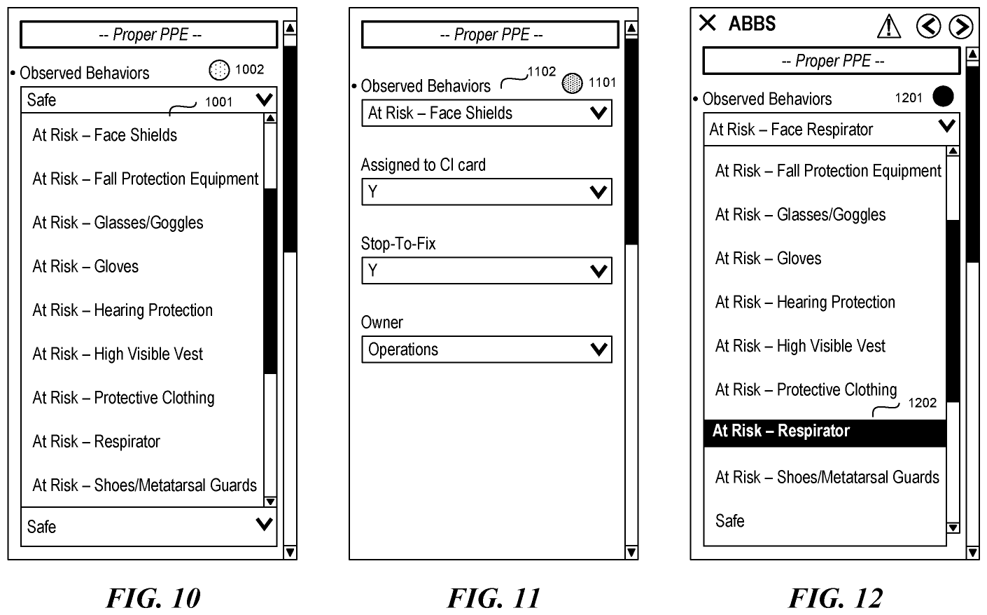

FIG. 10 is an example of an interface of the advanced behavior-based safety system for receiving a severity level associated with an observed safety violation from a user entity. In entry 1001, the advanced behavior-based safety system receives information regarding the observed safety violation. For example, the observed safety violations for the proper personal protective equipment (PPE) can be face shields, fall protection equipment, glasses/goggles, gloves, hearing protection, high visible vest, protective clothing, respirator, and/or shoes/metatarsal guards being at risk.

A severity level with a weighted risk value as indicated by element 1002 can be associated with each observed safety violation. For example, the sparsely spread dots of the indicator 1002 can indicate that the observed safety violation is minor with a severity level that is given a low weighted risk value. The densely spread dots of element 1101 of FIG. 11 can indicate that the observed safety violation is major with a severity level that is given a high weighted risk value. A fully filled dot of element 1201 of FIG. 12 can indicate that the observed safety violation is catastrophic with a severity level that is given a very high weighted risk value. The severity level is an assessment parameter of the observed safety violation that can be evaluated with other assessment parameters to determine whether the observed safety violation surpasses a notification threshold as determined by a risk assessment protocol. Each observed safety violation may have a severity level associated with it. In some embodiments, a severity level with a high or very high weighted risk value will cause the related observed safety violation to exceed the notification threshold when evaluated. An immediate notice may be transmitted to a management entity (e.g. the owner) entry when the notification threshold is exceeded. In some embodiments, a severity level with a low risk value will cause the related observed safety violation to not exceed the notification threshold when evaluated. Transmission of a notice to a management entity may be scheduled when the notification threshold is not exceeded.

FIG. 11 is an example of an interface of the advanced behavior-based safety system with default entries for an observed safety violation from a user entity. In entry 1102, the observed safety violation relates to face shields being at risk. The densely spread dots of element 1101 of FIG. 11 can indicate that the face shields risk is major with a severity level that is given a high weighted risk value. When the face shields are at risk, subsequent entries are populated with default entries, and the default entries will be received by the advanced behavior-based safety system when a user entity does not manually/explicitly specify those entries. The default entries for face shield being at risk include, “NA” (Not available) for being assigned to the CI card, “NA” (Not available) for the Stop-To-Fix option, and “TBD” (To be determined) being the owner or management entity. Other possible entries for the CI card and Stop-To-Fix options include “N” (No) and “Y” (Yes). The Stop-To-Fix (the management must be notified immediately and stop to fix the safety violation) option is set to “Yes” in FIG. 11 because the observed severity level is a high weighted risk value. The owner or management entity is “Operations” in FIG. 11 because it is responsible for addressing safety violations or risks related to face shields.

FIG. 12 is an example of an interface of the advanced behavior-based safety system for receiving an observed safety violation entry from a user entity. When the highlighted entry 1202 is selected, the advanced behavior-based safety system receives the observed safety violation “At Risk—Respirator” of proper personal protective equipment, which indicates that the respirator equipment is at risk and presents a safety violation. The fully filled dot of element 1201 of FIG. 12 can indicate that the face respirator risk is catastrophic with a severity level that is given a very high weighted risk value.

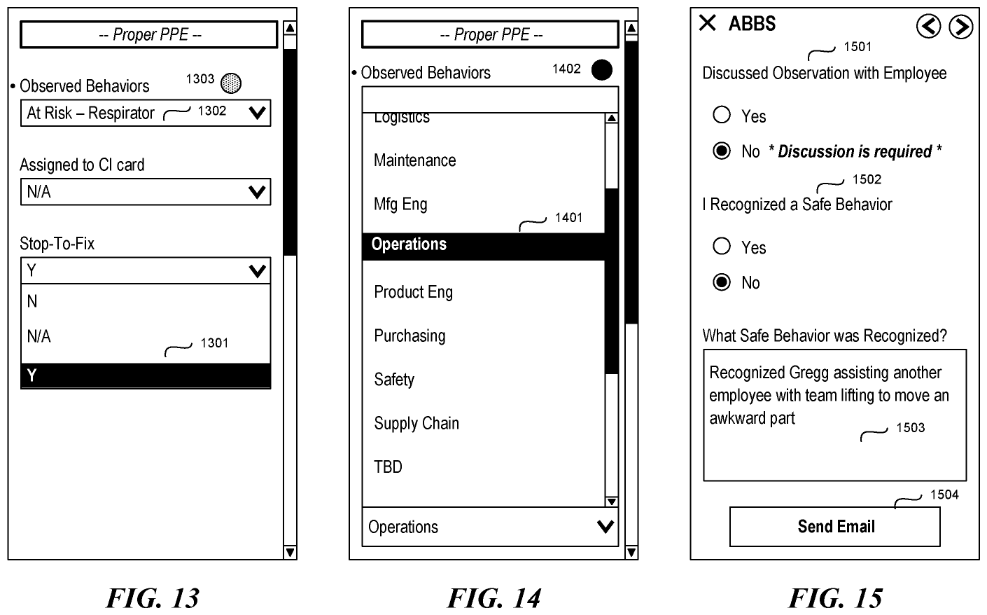

FIG. 13 is an example of an interface of the advanced behavior-based safety system for receiving a selection from a user entity to transmit an immediate notification of an observed safety violation to a management entity. The Stop-To-Fix entry indicates to the advanced behavior-based safety system whether a notice of the respirator safety violation in entry 1302 should be sent immediately to the management entity and request that the entity stops to fix the violation. When the highlighted entry 1301 of “Y” is selected, the advanced behavior-based safety system sets the risk value of the observed safety violation such that the observed safety violation exceeds the notification threshold according to the risk assessment protocol. Other possible entries include “N” (No), and “N/A” (not applicable). The partially filled dot of element 1303 can indicate that the respirator safety violation is major with a severity level that is given a high weighted risk value.

FIG. 14 is an example of an interface of the advanced behavior-based safety system for receiving management entity information from a user entity. One or more management entities can be reported to regarding the observed safety violation. Examples of management entities that can be reported to include, but are not limited to, logistics, maintenance, manufacturing engineering, operations, product engineering, purchasing, safety, and/or supply chain. In some embodiments, when a management entity of “TBD” (to be determined) is received, the advanced behavior-based safety system determines and assigns a management entity the observed safety violation. The management entity or owner can be an assessment parameter for the observed safety violation.

In some embodiments, the risk value of the severity level may be determined not just from the observed safety violation, but also assessment parameters of the observed safety violation. For example, a respiratory safety violation with a management entity (an assessment parameter) of operations may cause the severity level to increase in risk value (the operations management entity associates respirator safety violations with a high severity level). The increased severity level can result in element 1402 having a fully filled dot to indicate that the respirator safety violation is now catastrophic with a severity level that is given a very high weighted risk value.

FIG. 15 is an example of an interface of the advanced behavior-based safety system for receiving additional observation information from a user entity. The additional observation information further specifies data related to the observation and can be assessment parameters for the observed safety violations. In entry 1501, the advanced behavior-based safety system receives an indication of whether the observation was discussed with an employee or the observee. An indication of either “Yes” or “No” will be received. When an indication of “No” is received, the advanced behavior-based safety system may transmit a notice to the user entity requiring the user entity to discuss the observed safety violation with an employee or the observee. In entry 1502, the ABBs system receives from an observer entity an indication of whether a safe behavior was performed by an observee at the location and recognized. An indication of either “Yes” or “No” will be received. When safe behavior is recognized, the advanced behavior-based safety system can receive a comment 1503 from the user entity or observer detailing the safe behavior performed by the observee. For example, the user entity or observer may comment that the observee Gregg assisted another employee with lifting a part. When element 1504 is selected, the advanced behavior-based safety system will send an email with contents of the additional observation information to a designated email recipient.

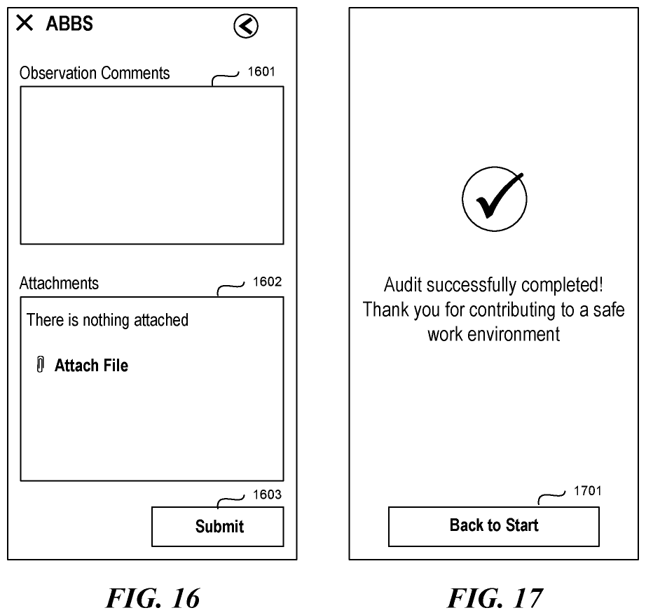

FIG. 16 is an example of an interface of the advanced behavior-based safety system for receiving observation comments and attachments from a user entity. The ability to use observation comments and attachments can be based on the user entity or require special permissions maintained by facility administrators. In entry 1601, the advanced behavior-based safety system can receive comments detailing the observation or observed safety violations from the user entity or observer's perspective. For example, an observer may point out more specific behavior they observed of an observee or equipment malfunction in the comments. The observer may also express a sense of urgency or recommended corrective behaviors for the safety violation in the comments. In entry 1602, the advanced behavior-based safety system may receive attachments of files associated with the observation or observed safety violations. The file attachments can include, but are not limited to, document reports, datasets collected, and/or camera images capturing the observation or observed safety violations. The comments 1601 can detail aspects of the file attachments (e.g. that an image captures a specific observed safety violation). The comments and file attachments can also be assessment parameters for the observed safety violation.

In some embodiments, when images capturing an observed safety violation are received, the advanced behavior-based safety system may transmit a request to another entity (e.g. audit entity, management entity, 3rd party entity) to confirm that the image captures an observed safety violation. In some embodiments, the advanced behavior-based safety system may receive a safety evaluation of the image from another entity detailing additional safety concerns that may exist from examining the image but might not have been captured by other assessment parameters of the observed safety violation. The safety evaluation can also be an assessment parameter for evaluating the observed safety violation against the notification threshold. In some embodiments, when a safety evaluation cannot be adequately performed, the advanced behavior-based safety system may receive a request for one or more additional file attachments to better perform a safety evaluation of the image. When element 1603 is selected, the advanced behavior-based safety system can receive all data (location information, observation information observed safety violations, severity risks, assessment parameters, additional observation information, comments, file attachments) associated with the observation entry as detailed in FIGS. 7-16.

FIG. 17 is an example of an interface of the advanced behavior-based safety system for displaying confirmation of receipt of an observation entry from a user entity. When the advanced behavior-based safety system successfully receives an observation entry submission from element 1603 of FIG. 16, the advanced behavior-based safety system may return confirmation of receipt to the user entity on its interface. When element 1603 is selected, the advanced behavior-based safety system interface will return to the interface of FIG. 6 and can receive a new observation entry from a user entity.

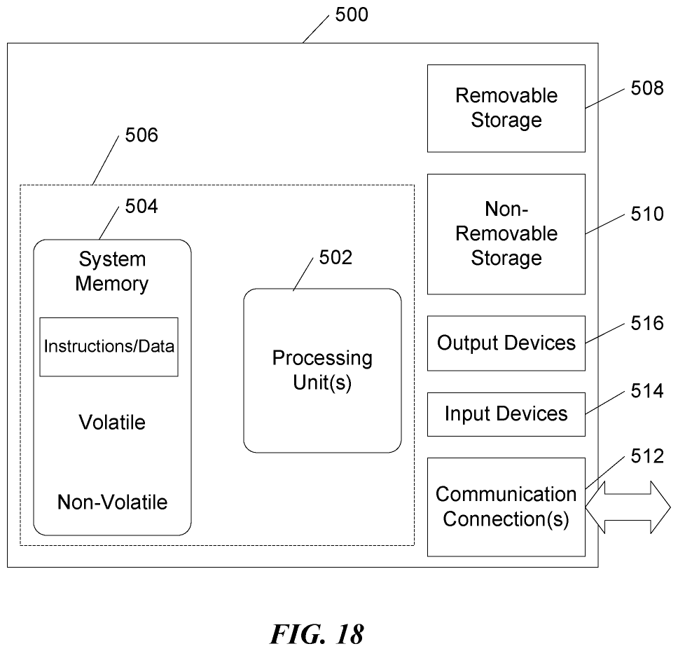

FIG. 18 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, information related to detected devices, association information, personal gateway settings, and instructions to perform the methods disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information. Computer storage media does not include communication media.

Communication media embodies non-transitory computer readable instructions, data structures, program modules, or other data. Computer readable instructions may be transported in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

### INDUSTRIAL APPLICABILITY

The advanced behavior-based safety system is a system that allows user entities to create safety observations and notify other entities of real-time observed safety violations at a location, which can be an industrial setting. Workers can report on observed behaviors at a location, including keeping an eye on other workers for violation of safety protocols and whether there are unsafe behaviors that may be detected with physical systems (e.g. machines, equipment, facility). Data is processed and managed via a single reliable and robust system that can transmit the data to different channels of interest securely, including those such as management entities, data evaluation entities, or auditor entities. When the advanced behavior-based safety system receives a safety observation, each of the observed safety violations (or risk behaviors) contains a set of assessment parameters that are evaluated to determine whether the observed safety violation exceeds a notification threshold according to a risk assessment protocol. Since one or more observed safety violations may be received with a safety observation, the observed safety violations may be processed and evaluated in aggregate or independently. When the notification threshold is surpassed, the advanced behavior-based safety system can transmit notices of observed safety violations to one or more entities, including management entities. These notices allow users to engage with managers, leaders, and/or supervisors regarding work progress and safety violations occurring during work progress at a location. Because the notifications are real-time, management entities can more reliably take the necessary responses in an immediate or scheduled fashion.

The advanced behavior-based safety system can allow user entities or management entities to transmit notices to auditor entities, which receive data associated with observed safety violations and determine mitigation or resolution procedures. By integrating auditors into the communication pipeline, the proper mitigation or resolution procedure for dealing with an observed safety violation can be communicated back to users or management to be carried out. Thus, the advanced behavior-based safety system adds to the communication map the ability for users or management to communicate with auditors to receive actual methods for dealing with safety concerns. Furthermore, the advanced behavior-based safety system integrates the collection and evaluation of sensory, temporal, or geoinformation data into the communication pipeline. Sensory, temporal, or geoinformation data can be listened for and received by the advanced behavior-based safety system, which can be subsequently transmitted to other entities for evaluation. An evaluation entity may determine that certain corrective behaviors need to be taken at the location, which can be transmitted back to user entities or management entities. The integration of sensory data into the communication pipeline allows for sensors at a location to be tapped into and the data harnessed to enrich information regarding the safety observation and observed safety violations. Users, managers, or auditors can be better informed and can take the necessary precautions as to prevent safety concerns or hazards from escalating. Notably, the incorporation of auditor entities and collection of sensory data adds to the robustness of the system for communicating safety violations to different channels.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A system comprising:
at least one process; and
memory coupled to the at least one processor, the memory comprising computer executable instructions, that when executed by the at least one processor, perform a computer-implemented method for escalated reporting of observed safety violations according to a dynamic risk assessment protocol, the method comprising:
receiving data associated with a first observed safety violation at a location, wherein the observed safety violation includes a set of assessment parameters, the set of assessment parameters comprising:
a location;
a severity level associated with the first observed safety violation, wherein the severity level of the first observed safety violation is associated with a default risk value weighted according to a risk assessment protocol; and
an identification of one or more entities associated with the first observed safety violation, wherein each of the one or more entities corresponds to at least one management entity having a unique notification address;
based upon the location, the severity level associated with the first observed safety violation, and the identification of the one or more entities, evaluating whether the first observed safety violation exceeds a notification threshold according to the risk assessment protocol; and
upon determining that the first observed safety violation does not exceed a notification threshold according to the risk assessment protocol, scheduling a transmission of a notice of the first observed safety violation to the management entity having the unique notification address.

2. The system of claim 1, wherein the location identifies a location identified by an associated risk-level.

3. The system of claim 1, wherein the risk value of the first observed safety violation is preconfigured with a default weight that when evaluated is above or below the notification threshold.

4. The system of claim 1, the processor performing the method comprising:
upon determining that the first observed safety violation exceeds the notification threshold according to the risk assessment protocol, transmitting a notice of the first observed safety violation to the management entity having the unique notification address.

5. The system of claim 1, the processor performing the method comprising:
transmitting a request to an observer entity, wherein the request indicates to an observer entity to immediately communicate the first observed safety violation with an observee entity.

6. The system of claim 1, the processor performing the method comprising:
receiving data associated with a second observed safety violation at the location;
evaluating whether the second observed safety violation exceeds the notification threshold according to the risk assessment protocol;
upon determining that the second observed safety violation does not exceed the notification threshold according to the risk assessment protocol, scheduling a transmission of a notice of the second observed safety violation to the management entity having the unique notification address;
determining an aggregation of the assessment parameters of the second observed safety violation and the first observed safety violation; and
upon determining that the aggregation exceeds the notification threshold according to the risk assessment protocol, transmitting immediately a notice of the second observed safety violation and the first observed safety violation to the management entity having the unique notification address.

7. The system of claim 6, the processor performing the method comprising:
evaluating whether the severity level associated with the second observed safety violation exceeds the severity level of the first observed safety violation; and
upon determining that the severity level of the second observed safety violation exceeds the severity level of the first observed safety violation, and determining that the second observed safety violation exceeds the notification threshold according to the risk assessment protocol, transmitting immediately a notice of the second observed safety violation to the management entity having the unique notification address, and deferring the scheduled transmission of the first observed safety violation.

8. The system of claim 6, the processor performing the method comprising:
transmitting a request for a response that the notice of the second observed safety violation was received to the management entity; and
upon indication that the response was not received, transmitting an escalated notice of the second observed safety violation to the management entity having the unique notification address.

9. The system of claim 6, the processor performing the method comprising:
selecting the first observed safety violation or second observed safety violation;
receiving a mitigation or resolution procedure determined by an auditor; and
assigning a set of responder entities to carry out the mitigation or resolution procedure.

10. The system of claim 9, the processor performing the method comprising:
transmitting a notice of the mitigation or resolution procedure to the set of responder entities so long as the mitigation or resolution procedure is incomplete; and
receiving data indicating that the mitigation or resolution procedure has been completed.

11. A computer-implemented method for escalated reporting of observed safety violations according to a dynamic risk assessment protocol, the method comprising:
receiving data associated with a first observed safety violation at a location, wherein the observed safety violation includes a set of assessment parameters, the set of assessment parameters comprising:
a location;
a severity level associated with the first observed safety violation, wherein the severity level of the first observed safety violation is associated with a default risk value weighted according to a risk assessment protocol; and
an identification of one or more entities associated with the first observed safety violation, wherein each of the one or more entities corresponds to at least one management entity having a unique notification address;
based upon the location, the severity level associated with the first observed safety violation, and the identification of the one or more entities, evaluating whether the first observed safety violation exceeds a notification threshold according to the risk assessment protocol;
upon determining that the first observed safety violation does not exceed a notification threshold according to the risk assessment protocol, scheduling a transmission of a notice of the first observed safety violation to the management entity having the unique notification address;
receiving data associated with a second observed safety violation at the location;
evaluating whether the severity level associated with the second observed safety violation exceeds the severity level of the first observed safety violation;
upon determining that the second observed safety violation does not exceed a notification threshold according to the risk assessment protocol, scheduling a transmission of a notice of the second observed safety violation to the management entity having the unique notification address;
determining an aggregation of the assessment parameters of the second observed safety violation and the first observed safety violation; and
upon determining that the aggregation exceeds the notification threshold according to the risk assessment protocol, transmitting immediately a notice of the second observed safety violation and the first observed safety violation to the management entity having the unique notification address.

12. The method of claim 11, wherein the location includes geographic location, longitude/latitude, facility name, cell number, section number, machine location, equipment location, machine number, equipment number, building area, building number, column number, column letter, office location, or outdoor location of the observed safety violation.

13. The method of claim 11, wherein the set of assessment parameters further includes a comment relevant to the first observed safety violation or second observed safety violation and one or more file attachments, wherein each of the one or more file attachments corresponds to an image taken from a camera to capture the first observed safety violation or second observed safety violation.

14. The method of claim 13, comprising:
receiving a safety evaluation of the image; and
based upon the safety evaluation, the location, the severity level associated with the first observed safety violation or second observed safety violation, and the identification of the one or more entities, evaluating whether the first observed safety violation or second observed safety violation exceeds the notification threshold according to the risk assessment protocol.

15. The method of claim 11, comprising:
receiving a plurality of sensory, temporal, or geoinformation data collected at the location;
transmitting the plurality of sensory, temporal, or geoinformation data to a cloud;
receiving a safety routine or a safety warning relevant to the location;
receiving one or more corrective behaviors associated with the location; and
transmitting a notice of the corrective behaviors associated with the location to the management entity.

16. The method of claim 15, comprising:
querying the plurality of sensory, temporal, or geoinformation data collected at the location.

17. A computer-readable media storying non-transitory computer executable instructions that when executed cause a computing system to perform a method for escalated reporting of observed safety violations according to a dynamic risk assessment protocol, the method comprising:
receiving data associated with a first observed safety violation at a location, wherein the observed safety violation includes a set of assessment parameters, the set of assessment parameters comprising:
a location;
a severity level associated with the first observed safety violation, wherein the severity level of the first observed safety violation is associated with a default risk value weighted according to a risk assessment protocol; and
an identification of one or more entities associated with the first observed safety violation, wherein each of the one or more entities corresponds to at least one management entity having a unique notification address;
based upon the location, the severity level associated with the first observed safety violation, and the identification of the one or more entities, evaluating whether the first observed safety violation exceeds a notification threshold according to the risk assessment protocol;
upon determining that the first observed safety violation does not exceed a notification threshold according to the risk assessment protocol, scheduling a transmission of a notice of the first observed safety violation to the management entity having the unique notification address;
receiving data associated with a second observed safety violation at the location;
evaluating whether the severity level associated with the second observed safety violation exceeds the severity level of the first observed safety violation;
upon determining that the second observed safety violation does not exceed a notification threshold according to the risk assessment protocol, scheduling a transmission of a notice of the second observed safety violation to the management entity having the unique notification address;
determining an aggregation of the assessment parameters of the second observed safety violation and the first observed safety violation; and
upon determining that the aggregation exceeds the notification threshold according to the risk assessment protocol, transmitting immediately a notice of the second observed safety violation and the first observed safety violation to the management entity having the unique notification address.

18. The computer-readable media of claim 17, wherein the set of assessment parameters further includes an observer, a supervisor, a value stream, or an observee.

19. The computer-readable media of claim 17, wherein the method further comprises:
receiving an indication that a safe behavior is performed by an observee at the location from an observer entity; and
receiving a comment from the observer entity detailing the safe behavior performed by the observee.

20. The computer-readable media of claim 17, wherein the notification threshold according to the risk assessment protocol is adjustable.
